(19) United States
(12) Patent Application Publication
(10) Pub. No.: US 2009/0118894 A1
(43) Pub. Date: May 7, 2009

(54) METHOD AND SYSTEM FOR DIAGNOSING THE CONDITION OF A MOTOR VEHICLE TYRES

(75) Inventors: Denis Le Bret, Chaville (FR); Zahir Djama, Paris (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/067,172

(22) PCT Filed: Sep. 11, 2006
(86) PCT No.: PCT/FR2006/050868

§ 371 Date: Aug. 29, 2008

(30) Foreign Application Priority Data
Sep. 16, 2005 (FR) 0509504

(51) Int. Cl. B60C 23/06

(52) U.S. Cl. 701/29

(57) ABSTRACT

The invention concerns a method for diagnosing the condition of tires of a front wheel and of a rear wheel of a motor vehicle arranged on the same side of the vehicle and connected to the body shell thereof via suspension means. Said method includes a step (102) of acquiring the vertical acceleration of said wheels in a reference model of the vehicle, a step (104) of time-based resetting of one of the acquired accelerations on the other of the acquired accelerations, a step (112) of estimating the coefficients of stiffness of the tires based on the thus temporally reset accelerations, and a step (120) of determining the condition of the tires based on the estimated coefficients of stiffness.

The present invention concerns a method of diagnosing the state of tires of a front wheel and of a rear wheel of a motor vehicle arranged on a same side of the vehicle and connected to the body thereof by means of suspensions, the method including a step of acquiring vertical accelerations of said wheels in a referential of the vehicle.

The present invention also concerns a diagnostic system implementing such a method.

Methods exist that use the measurement of the rotation speed of a vehicle wheel to diagnose the state of the tire thereof, and in particular its under-inflated state. However, an under-inflated state, if it is not quickly corrected, triggers an irreversible alteration of the dynamic behavior of the tire, even after it has been re-inflated, which is impossible to diagnose with methods of the state of the art.

The objective of the present invention is to remedy the above-mentioned problem by proposing a method and a system capable of diagnosing anomalies of a tire, such as tread separation or wear, even if this tire is appropriately inflated.

To this effect, an object of the invention is a method of diagnosing the state of tires of a front wheel and of a rear wheel of a motor vehicle arranged on a same side of the vehicle and connected to the body thereof by means of suspensions, the method including a step of acquiring the vertical accelerations of said wheels in a referential of the vehicle, characterized in that it comprises:
a step of temporally resetting one of the acquired accelerations on the other of the acquired accelerations;
a step of estimating coefficients of stiffness of the tires as a function of the thus temporally reset accelerations; and
a step of determining the state of the tires as a function of the estimated coefficients of stiffness;
the temporally resetting step comprises a step of calculating the inter-correlation between the acquired accelerations and a step of applying a delay corresponding to the maximum of the calculated inter-correlation to the acquired acceleration of the front wheel;
the coefficient of stiffness estimating step is adapted to estimate these coefficients of stiffness from mono-wheel mechanical models of said wheels connected to the body of the vehicle by means of the suspensions;
the coefficient of stiffness estimating step is adapted to estimate these coefficients of stiffness based on a model in discrete time of the reset accelerations of said wheels according to the equation:

$$Avr ( k ) = \frac{1}{mrr} ( mra \times Ava ( k - n ) Zva ( k - n ) - Zvr ( k ) ) ( \begin{matrix}Kpr ( k ) / Kpa ( k ) \\ Kpr ( k )\end{matrix} )$$

where k is the k^{th} sampling instant, mrr and mra are the masses of the rear and front wheel, respectively, Avr and Ava are the vertical accelerations of the rear and front wheels, respectively, Zvr and Zva are the altitudes of the centers of the rear and front wheels, respectively, in the referential of the vehicle, Kpr and Kpa are the coefficients of stiffness of the tires of the front and rear wheels, respectively, and n is a resetting instant corresponding to a temporal delay between the rear and front wheel subjected to the same portion of the roadway;
the estimating step is adapted to estimate said coefficients of stiffness based on a model in discrete time of the reset accelerations of the front and rear wheels according to the equation:

$$Ava ( k ) = \frac{1}{mra} ( mrr \times Avr ( k + n ) Zvr ( k + n ) - Zva ( k ) ) ( \begin{matrix}Kpa ( k ) / Kpr ( k ) \\ Kpa ( k )\end{matrix} )$$

where k is the k^{th} sampling instant, mrr and mra are the masses of the rear and front wheel, respectively, Avr and Ava are the vertical accelerations of the rear and front wheels, respectively, Zvr and Zva are the altitudes of the centers of the rear and front wheels, respectively, in the referential of the vehicle, Kpr and Kpa are the coefficients of stiffness of the tires of the front and rear wheels, respectively, and n is a resetting instant corresponding to a temporal delay between the rear and front wheel subjected to the same portion of the roadway;
the estimating step is adapted to estimate said coefficients of stiffness from a bicycle mechanical model of the body assimilated to a mass connected to the front and rear wheels by means of the suspensions;
the estimating step is adapted to estimate said coefficients of stiffness based on a model in discrete time of the reset accelerations of the front and rear wheels according to the equation:

$$Avr ( k ) = {( \begin{matrix}\frac{mra}{mrr} Ava ( k - n ) \\ \frac{1}{mrr} ( Zva ( k - n ) - Zvr ( k ) ) \\ \frac{1}{mnr} \dot{Z} va ( k - n ) \\ - \frac{1}{mrr} \dot{Z} vr ( k )\end{matrix} )}^{T} ( \begin{matrix}Kpr ( k ) / Kpa ( k ) \\ Kpr ( k ) \\ ( Kpr ( k ) / Kpa ( k ) ) \times Kca ( k ) \\ Kcr ( k )\end{matrix} )$$

where k is the k^{th} sampling instant, mrr and mra are the masses of the rear and front wheel, respectively, Avr and Ava are the vertical accelerations of the rear and front wheels, respectively, Zvr and Zva are the altitudes of the centers of the rear and front wheels, respectively, in the referential of the vehicle, Kpr and Kpa are the coefficients of stiffness of the tires of the front and rear wheels, respectively, n is a resetting instant corresponding to a temporal delay between the rear and front wheel subjected to the same portion of the roadway, Kca and Kcr are coefficients of stiffness of the suspensions of the front and rear wheels, respectively, and Żva et Żvr are the speeds of the centers of the front and rear wheels, respectively;
the coefficient of stiffness estimating step is adapted to implement a recursive least square algorithm in real time;
the tire state determining step comprises, for each tire, a step of comparing its determined coefficient of stiffness to a predetermined threshold value and a step of diagnosing the state of the tire adapted to determine that this tire is defective if its determined coefficient of stiffness is higher than the threshold value;

The invention concerns a system for diagnosing the state of tires of a front wheel and of a rear wheel of a motor vehicle arranged on a same side of the vehicle and connected to the body thereof by means of suspensions, the system including means for acquiring the vertical accelerations of said wheels in a referential of the vehicle, characterized in that it is adapted to implement a method as defined above.

Another object of the invention is a system adapted to implement the above-mentioned method.

The invention will be better understood by reading the following description made by way of example only in reference to the annexed drawings in which:

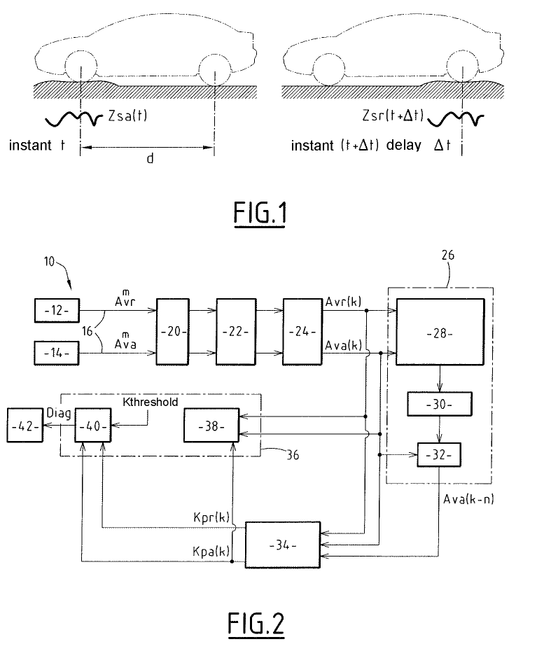

FIG. 1 is a schematic drawing illustrating the calculation hypothesis used by the system according to the invention;

FIG. 2 is a schematic view of a first embodiment of the system according to the invention;

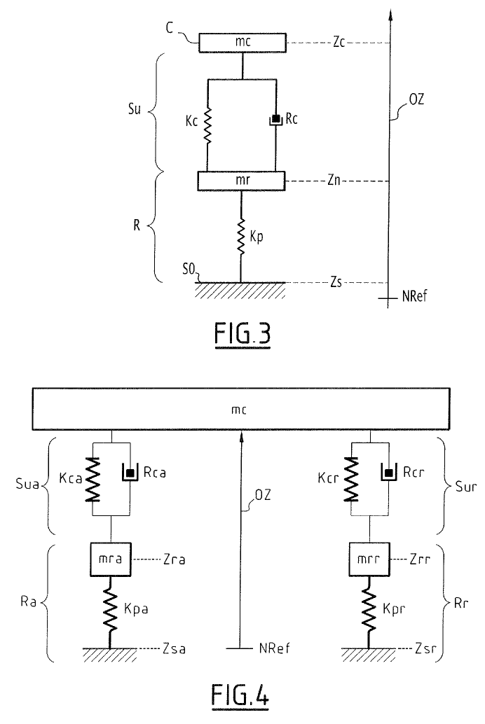

FIG. 3 is a schematic view of a mechanical model of a motor vehicle wheel connected to the body thereof by means of a suspension;

FIG. 4 is a schematic view of a second mechanical model of a front and rear wheel of a motor vehicle arranged on a same side of the vehicle and connected to the body thereof by means of suspension; and

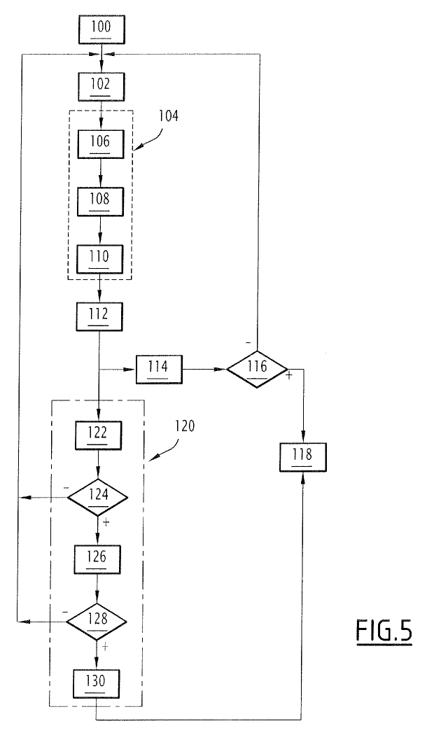

FIG. 5 is a flow chart of the method according to the invention implemented by the system of FIG. 3.

FIG. 1 illustrates the progress of a motor vehicle on a roadway between two instants t and t+Δt.

As illustrated on this Figure, the front and rear wheels arranged on the same side of the vehicle are subjected to the same profile of the roadway with a temporal delay Δt dependent on the speed V and on the wheel base d of the vehicle. This phenomenon can be modelized according to the equation:

Zsa(t)=Zsr(t+Δt) (1)

where t is time, Δt is the time period separating the passage of the rear wheel on a point of the roadway from the passage of the front wheel on this same point, Zsa is the altitude of the ground in the area of the front wheel and Zsr is the altitude of the ground in the area of the rear wheel.

FIG. 2 illustrates schematically, under general reference numeral 10, a first embodiment of the system according to the invention for diagnosing the state of tires of a front wheel and of a rear wheel of a motor vehicle arranged on a same side of the vehicle and connected to the body thereof by means of suspensions.

This system 10 comprises an accelerometer 12, 14 with which each of these wheels is equipped to measure the acceleration Ava, Avr at its center according to a vertical axis in a referential of the vehicle. This accelerometer 12, 14 is, for example, a mono-axis or tri-axis accelerometer mounted at the center of the wheel. It is adapted to supply, via a wire connection 16, a signal representative of the vertical acceleration Avr, Ava at the center of the wheel.

Means 20 are provided in the system 10 to receive the signals emitted by the accelerometers 12, 14 and to extract from these signals the accelerations Avr, Ava measured by these accelerometers.

The means 20 are connected to a band-pass filter 22 adapted to process the accelerations Avr, Ava of the wheels supplied by the means 20 by applying to them a band-pass filtering operation. This filtering operation is implemented in a frequency range in which the power of the modes of the front and rear wheels is essentially concentrated. This frequency range corresponds to the range of rolling resistance and is, for example, substantially equal to the range [8; 20] Hz.

Further, the band-pass filter 22 is connected to an analog/digital converter 24, for example, a zero order blocker-sampler, adapted to digitalize, according to a predetermined sampling period Te, for example, comprised between about 0.001 seconds and 0.02 seconds, the filtered accelerations, and thus, to supply as output digital accelerations Avr(k), Ava(k) of the front and rear wheels, where k represents the k^{th} sampling instant.

Of course, a different arrangement of the elements that have just been described is possible. For example, the sampling of the accelerations can be performed before a band-pass filtering performed in discrete time.

The system 10 according to the invention also includes temporally resetting means 26 connected to the converter 24 and adapted to temporally reset the digital acceleration Ava(k) of the front wheel on the digital acceleration Avr(k) of the rear wheel to supply as output reset accelerations Avr(k), Ava(k-n) of the front and rear wheels, corresponding to the same altitude of the ground in order to apply the hypothesis according to equation (1) described above.

To this effect, these resetting means 26 comprise computing means adapted to estimate the digital inter-correlation IC(N) of the accelerations Avr(k), Ava(k) supplied by the converter 24 according to the equation:

$$IC ( N ) = {\sum }_{k = - ∞}^{+ ∞} Avr ( k ) \times Ava ( N - k ) \qquad ( 2 )$$

The computing means 28 are adapted to implement an estimator of this inter-correlation, as is known in itself in the field of signal processing.

The resetting means 26 also comprise, connected to the computing means 28, means 30 for determining the maximum of the inter-correlation IC(N) and of the sampling instant n corresponding to this maximum. This instant n thus corresponds to the temrporal delay n×Te between the front and rear wheels subjected to the same portion of the roadway.

The temporal resetting means 32 are connected to the means 30 and to the converter 24, and are adapted to apply a delay of n samples to the acceleration Ava(k) of the front wheel and thus to supply an acceleration Ava(k-n) temporally reset on the acceleration Avr(k) of the rear wheel.

The system 10 further comprises means 34 for estimating the coefficients of pneumatic stiffness Kpr, Kpa of the front and rear wheels. These means 34 are connected to the converter 24 to receive the accelerations Avr(k), Ava(k) of the rear and front wheels and to the resetting means 26 to receive the reset acceleration Ava(k-n) of the front wheel.

The means 34 are based on the mechanical model of FIG. 3 to model the dynamic behavior of each of the front and rear wheels.

On this Figure, a mono-wheel mechanical model of a wheel R of a four-wheel motor vehicle is illustrated, this wheel R being connected to the body C thereof by means of a suspension Su, the wheel R being in contact with the ground So.

The body C is modeled by a mass mc reported to the wheel that is located, on a vertical axis OZ of the vehicle in a referential thereof, at an altitude Zₑ with respect to a reference level NRef, for example, the altitude of the ground So in the area of the front wheel when the vehicle is starting off.

The suspension Su is modeled by a spring having a coefficient of stiffness Kc in parallel with a damper having a damping coefficient Rc. The wheel R is modeled by a mass Mr located on the axis OZ at an altitude Zr with respect to the reference level Nref. The tire thereof is modeled by a spring having a coefficient of stiffness Kp in contact with the ground So which is located on the axis OZ at an altitude Zs with respect to the reference level Nref.

When the vehicle is moving, the behavior of this mechanical system is controlled by the evolution of the altitude Zs of the ground with time.

In the following, the letter “a” is added to the designations of the above-mentioned magnitudes for the magnitudes associated with a front wheel and the letter “r” is added to the above-mentioned designations for the magnitudes associated with a rear wheel.

Using the fundamental principle of dynamics applied to this model in relation with the hypothesis according to equation (1), the vertical accelerations Ava(k), Ava(k) of the centers of the wheels are modeled in discrete time according to the equations:

$$\begin{matrix}Avr ( k ) = \frac{1}{mrr} ( mra \times Ava ( k - n ) Zva ( k - n ) - Zvr ( k ) ) ( \begin{matrix}Kpr ( k ) / Kpa ( k ) \\ Kpr ( k )\end{matrix} ) & ( 3 ) \\ Ava ( k ) = \frac{1}{mra} ( mrr \times Avr ( k + n ) Zvr ( k + n ) - Zva ( k ) ) ( \begin{matrix}Kpa ( k ) / Kpr ( k ) \\ Kpa ( k )\end{matrix} ) & ( 4 )\end{matrix}$$

where mrr and mra are the masses of the rear and front wheels, respectively, and Zvr and Zva are the altitudes of the centers of the rear and front wheels, respectively, with respect to the reference level.

Referring again to FIG. 2, the estimating means 34 are adapted to implement a recursive least square algorithm in real time based equation (3), according to the equations:

\hat{θ}(k+1)=\hat{θ}(k)+K(k+1)(Avr(k+1)−A(k+1)\hat{θ}(k)) (5)

K(k+1)= ω̅⁻¹S(k)X^{T}(k+1)(σ²(k)+ ω̅⁻¹A(k+1)S(k)A^{T}(k+1))⁻¹ (6)

S(k+1)= ω̅⁻¹(S(k)−K(k+1)A(k+1)S(k)) (7)

X(k+1)=E(A^{T}(k+1)A(k+1))⁻¹ (8)

σ(k)=Var(e(k)) (9)

where ()^{T} is the symbol of the transpose, \hat{θ}(k) is the estimate of the vector of the parameters

$$θ = ( \begin{matrix}Kpr / Kpa \\ Kpr\end{matrix} )$$

at instant k, A(k) is the regression vector

$$( \frac{mrr}{mra} \times Avr ( k + n ) \frac{1}{mra} ( Zva ( k - n ) - Zvr ( k ) ) )$$

at instant k, E(A^{T}(k)A(k)) is the variance of the vector A^{T} at instant k, Var(e(k)) is the variance of the estimation error e(k)=Avr(k)−A(k)\hat{θ}(k) at instant k, ω̅ is a predetermined forgetting factor and K(k), X(k) et S(k) are intermediate vectors or matrices used during the estimation of the vector θ.

Preferably, the means 34 are adapted to calculate the altitudes Zvr(k), Zva(k-n) of the centers of the rear and front wheels at each sampling instant as a function of the vertical accelerations Avr(k) and Ava(k-n), for example, by performing a double integration thereof after filtering them between 8 Hz and 20 Hz. Another example of a calculation of the altitude of a wheel is described in the French patent application FR 2 858 267 in the name of the applicant.

As a variant, the estimating means 34 are adapted to implement a recursive least square algorithm in real time based on equation (4) in a manner analogous to that described above.

As a variant, the means 34 are adapted to implement an inversion or deconvolution algorithm based on equation (3) or (4) to estimate the coefficients of stiffness.

The estimating means 34 are thus adapted to supply, at each sampling instant, estimated values Kpa(k) and Kpr(k) of the coefficients of pneumatic stiffness of the front and rear wheels.

Finally, the system 10 comprises means 36 for diagnosing the operating state of the accelerometers 12, 14 and the state of the tires of the front and rear wheels, connected to the estimating means 34 and to the converter 24.

The means 36 comprise means 38 for diagnosing the operating state of the accelerometers adapted to test the coherence of the accelerations Avr(k) and Ava(k) with each other over a predetermined time period, for example, comprised between 5 and 10 minutes. As described above, it is known that the vertical accelerations of the front and rear wheels are coherent since the wheels are subjected to the same portion of the roadway with a temporal delay.

For example, the means 38 are adapted to calculate the frequency specters of these accelerations by means of a fast Fourier transform of the accelerations comprised in the predetermined time period and to compare the calculated specters. If these specters differ by more than a predetermined value, for example, in quadratic error, then the accelerometers are diagnosed as defective by the means 38.

For additional robustness in the diagnostic of the operating state of the accelerometers, as a variant, the means 38 are further adapted to predict the vertical acceleration of the rear wheel as a function of the vertical acceleration of the front wheel supplied by the converter 24 and of the coefficients of stiffness of the front and rear wheels calculated by the means 34, from equation (3), by varying the sampling instant n. The means 38 are also adapted to test the coherence between this predicted acceleration of the rear wheel and the acceleration of the front wheel supplied by the converter 24, for example, in the manner described above for the accelerations supplied by the converter 24.

If, in addition, the coherence between these accelerations is not established, then the means 38 diagnose a malfunction of the accelerometers 12, 14.

The means 36 also comprise means 40 for determining the state of the tires connected to the estimating means 34. The means 40 are adapted to compare each of the estimated coefficients of stiffness Kpr(k), Kpa(k) with a predetermined threshold value Kthreshold and to determine that the corresponding tire is defective if the estimated coefficient of stiffness Kpr(k), Kpa(k) has at least N values higher than the threshold value Kthreshold, where N is a predetermined integral number, for example, equal to 100.

Finally, the means 36 are connected to means 42 for supplying to the driver of the vehicle the results of the diagnostic performed by the means 36, for example, light indicators arranged on the dashboard of the vehicle and/or sound signal of the defective state of the tires or of the defective state of the accelerometers.

An embodiment based on a mono-wheel mechanical model as illustrated on FIG. 3 has just been described.

Other embodiments of the system according to the invention based on other models are possible. Such embodiments are structurally identical to those illustrated on FIG. 2, only the algorithm implemented by the estimating means 34 being modified.

For example, as a variant, the system is based on a mechanical model illustrated on FIG. 4. FIG. 4 is a schematic view of a mechanical model generally designated under the expression “bicycle model.” This type of model makes it possible in particular to take into account the case of active suspensions with which the vehicle is equipped and it applies to front and rear wheels arranged on a same side of the vehicle.

The difference with the model of FIG. 1 resides in that the body C of the vehicle is assimilated to a mass mc suspended both on the front wheel Ra and on the rear wheel Rr.

Based on the fundamental principle of dynamics applied to this bicycle model, as well as on the hypothesis according to equation (1), the vertical accelerations Ava(k), Avr(k) of the front and rear wheels are modeled in discrete time according to the equation:

$$Avr ( k ) = {( \begin{matrix}\frac{mra}{mrr} Ava ( k - n ) \\ \frac{1}{mrr} ( Zva ( k - n ) - Zvr ( k ) ) \\ \frac{1}{mnr} \dot{Z} va ( k - n ) \\ - \frac{1}{mrr} \dot{Z} vr ( k )\end{matrix} )}^{T} ( \begin{matrix}Kpr ( k ) / Kpa ( k ) \\ Kpr ( k ) \\ ( Kpr ( k ) / Kpa ( k ) ) \times Kca ( k ) \\ Kcr ( k )\end{matrix} ) \qquad ( 10 )$$

where Żva and Żvr are the first derivatives of the altitudes of the centers of the front and rear wheels, respectively, i.e., the speeds of the vertical movement of these wheels.

The estimating means 34 are then adapted to implement a recursive least square algorithm in real time based on equation (11).

This algorithm is analogous to that described above (equations (6) to (10)) with the vector of the parameters defined by the equation:

$$θ = ( \begin{matrix}Kpr / Kpa \\ Kpr \\ ( Kpr / Kpa ) \times Kca \\ Kcr\end{matrix} ) \qquad ( 12 )$$

and the regression vector defined by the equation:

$$A ( k ) = ( \frac{mra}{mrr} Ava ( k - n ) \frac{1}{mrr} ( Zva ( k - n ) - Zvr ( k ) ) \frac{1}{mnr} \dot{Z} va ( k - n ) - \frac{1}{mrr} \dot{Z} vr ( k ) ) \qquad ( 13 )$$

The altitudes Zvr(k), Zva(k-n) of the centers of the wheels with respect to the reference level and their first derivatives Żvr(k), Żva(k-n) are calculated at each sampling step in a manner analogous to the first embodiment, for example, by integrating the corresponding vertical accelerations, or in a manner described in French patent application FR 2 858 267.

As it can be observed, the application of the recursive least square algorithm in real time based on the bicycle model makes it possible to estimate simultaneously the coefficients of pneumatic stiffness Kpa, Kpr as well as the coefficients of stiffness Ra and Rr of the suspensions.

FIG. 5 is a flow chart of the method according to the invention implemented by the system of FIG. 2.

A first step 100 consists in initializing to zero a counter of anomalies of the tire of the front wheel and a counter of anomalies of the tire of the rear wheel.

In a second, subsequent acquisition step 102, the vertical accelerations Ava, Avr of the front and rear wheels are measured, filtered, and sampled.

A step 104 of resetting the acceleration Ava of the front wheel on the acceleration Avr of the rear wheel is then triggered.

This step 104 comprises a step 106 of calculating the inter-correlation of the digital accelerations Ava(k), Avr(k) of the front and rear wheels followed by a step 108 of calculating the sampling instant n of the maximum of the calculated inter-correlation.

The digital acceleration Ava(k) of the front wheel is then reset at 110 by the instant n on the digital acceleration Avr(i) of the rear wheel.

Subsequently to the resetting step 104, the coefficients of stiffness Kpa(k), Kpr(k) are calculated at 112 as a function of the reset digital accelerations by implementing a recursive least square algorithm in real time based on the mono-wheel model or on the bicycle model, as described above.

A step 114 of diagnosing the state of the accelerometers 12, 14 is then triggered, as described above. A test is then performed at 116 to know whether at least one of them is defective. If the result of this test is negative, the step 116 loops back to step 102. Otherwise, a sound and/or visual alarm is triggered at 118 to warn the driver of the vehicle of a failure of the accelerometers.

Subsequently to the estimating step 112, a step 120 of determining the state of the tires is also triggered.

This step 120 comprises a step 122 of comparing each coefficient of stiffness Kpa(k), Kpr(k) estimated at 112 to the threshold value Kthreshold. A test is performed at 124 to know whether the coefficient of stiffness has at least a value higher to the threshold value Kthreshold. If the result of this test is positive, the corresponding counter of anomalies is incremented at 126 by the number of values thereof higher than the threshold value.

A test is then implemented at 128 to know whether the value of this counter is higher than N. If this is the case, the corresponding tire is diagnosed at 130 as defective and the step 118 is triggered to warn the driver of this failure.

If none of the counters of anomalies is higher than N, then step 128 loops back to acquiring step 102.

Finally, if none of the estimated coefficients of stiffness has a value higher than the threshold value Kthreshold, then step 124 loops back to acquiring step 102.

It is observed that the system and the method according to the invention diagnose a defective state of a tire and this even if this tire is inflated in an appropriate manner. The system and the method according to the invention make it possible to detect a situation where a tire is under-inflated or its tread is worn off or separated.

A system according to the invention has been described as applied to a pair of front and rear wheels of a motor vehicle arranged on a same side thereof. Of course, it is understood that the system can also be applied to each of the pairs of front and rear wheels arranged on a same side of the vehicle.

1. Method of diagnosing the state of tires of a front wheel and of a rear wheel of a motor vehicle arranged on a same side of the vehicle and connected to the body thereof by means of suspensions, the method including a step of acquiring the vertical accelerations of said wheels in a referential of the vehicle, wherein said method comprises:
a step of temporally resetting one of the acquired accelerations on the other of the acquired accelerations;
a step of estimating coefficients of stiffness of the tires as a function of the thus temporally reset accelerations; and
a step of determining the state of the tires as a function of the estimated coefficients of stiffness.

2. Method according to claim 1, wherein the temporally resetting step comprises a step of calculating the inter-correlation between the acquired accelerations and a step of applying a delay corresponding to the maximum of the calculated inter-correlation to the acquired acceleration of the front wheel.

3. Method according to claim 1, wherein the coefficient of stiffness estimating step is adapted to estimate these coefficients of stiffness from mono-wheel mechanical models of said wheels connected to the body of the vehicle by means of the suspensions.

4. Method according to claim 3, wherein the coefficient of stiffness estimating step is adapted to estimate these coefficients of stiffness based on a model in discrete time of the reset accelerations of said wheels according to the equation:
$$Avr ( k ) = \frac{1}{mrr} ( mra \times Ava ( k - n ) Zva ( k - n ) - Zvr ( k ) ) ( \begin{matrix}Kpr ( k ) / Kpa ( k ) \\ Kpr ( k )\end{matrix} )$$
where k is the k^{th} sampling instant, mrr and mra are the masses of the rear and front wheel, respectively, Avr and Ava are the vertical accelerations of the rear and front wheels, respectively, Zvr and Zva are the altitudes of the centers of the rear and front wheels, respectively, in the referential of the vehicle, Kpr and Kpa are the coefficients of stiffness of the tires of the rear and front wheels, respectively, and n is a resetting instant corresponding to a temporal delay between the rear and front wheel subjected to the same portion of the roadway.

5. Method according to claim 3, wherein the estimating step is adapted to estimate said coefficients of stiffness based on a model in discrete time of the reset accelerations of the front and rear wheels according to the equation:
$$Ava ( k ) = \frac{1}{mra} ( mrr \times Avr ( k + n ) Zvr ( k + n ) - Zva ( k ) ) ( \begin{matrix}Kpa ( k ) / Kpr ( k ) \\ Kpa ( k )\end{matrix} )$$
where k is the k^{th} sampling instant, mrr and mra are the masses of the rear and front wheel, respectively, Avr and Ava are the vertical accelerations of the rear and front wheels, respectively, Zvr and Zva are the altitudes of the centers of the rear and front wheels, respectively, in the referential of the vehicle, Kpr and Kpa are the coefficients of stiffness of the tires of the rear and front wheels, respectively, and n is a resetting instant corresponding to a temporal delay between the rear and front wheel subjected to the same portion of the roadway.

6. Method according to claim 1, wherein the estimating step is adapted to estimate said coefficients of stiffness from a bicycle mechanical model of the body assimilated to a mass connected to the front and rear wheels by means of the suspensions.

7. Method according to claim 5, wherein the estimating step is adapted to estimate said coefficients of stiffness based on a model in discrete time of the reset accelerations of the front and rear wheels according to the equation:
$$Avr ( k ) = {( \begin{matrix}\frac{mra}{mrr} Ava ( k - n ) \\ \frac{1}{mrr} ( Zva ( k - n ) - Zvr ( k ) ) \\ \frac{1}{mnr} \dot{Z} va ( k - n ) \\ - \frac{1}{mrr} \dot{Z} vr ( k )\end{matrix} )}^{T} ( \begin{matrix}Kpr ( k ) / Kpa ( k ) \\ Kpr ( k ) \\ ( Kpr ( k ) / Kpa ( k ) ) \times Kca ( k ) \\ Kcr ( k )\end{matrix} )$$
Where k is the kth sampling instant, mrr and mra are the masses of the rear and front wheel, respectively, Avr and Ava are the vertical accelerations of the rear and front wheels, respectively, Zvr and Zva are the altitudes of the centers of the rear and front wheels, respectively, in the referential of the vehicle, Kpr and Kpa are the coefficients of stiffness of the tires of the rear and front wheels, respectively, n is a resetting instant corresponding to a temporal delay between the rear and front wheel subjected to the same portion of the roadway, Kca and Kcr are coefficients of stiffness of the suspensions of the front and rear wheels, respectively, and Żva et Żvr are the speeds of the centers of the front and rear wheels, respectively.

8. Method according to claim 1, wherein the coefficient of stiffness estimating step is adapted to implement a recursive least square algorithm in real time.

9. Method according to claim 1, wherein the tire state determining step comprises, for each tire, a step of comparing its determined coefficient of stiffness to a predetermined threshold value and a step of diagnosing the state of the tire adapted to determine that this tire is defective if its determined coefficient of stiffness is higher than the threshold value.

10. System for diagnosing the state of tires of a front wheel and of a rear wheel of a motor vehicle arranged on a same side of the vehicle and connected to the body thereof by means of suspensions, the system including means for acquiring the vertical accelerations of said wheels in a referential of the vehicle, wherein said system comprises:
means for temporally resetting one of the acquired accelerations based on the other acquired acceleration;
means for estimating coefficients of stiffness of the tires as a function of the thus temporally reset accelerations; and
means for determining the state of the tires as a function of the estimated coefficients of stiffness,
said means being adapted to implement the method according to claim 1.
